(19) United States
(12) Patent Application Publication
(10) Pub. No.: US 2007/0257017 A1
(43) Pub. Date: Nov. 8, 2007

(54) Calibrated thermal sensing system

(76) Inventors: Alfred R. Deangelis, Spartanburg, SC (US); Joshua D. Horvath, Fallston, MD (US); Andrew D. Child, Moore, SC (US)

Correspondence Address: Legal Department (M-495), P.O. Box 1926, Spartanburg, SC, 29304, US

(21) Appl. No.: 11/417,727

(22) Filed: May 4, 2006

(51) Int. Cl. H05B 3/00

(52) U.S. Cl. 219/211

(57) ABSTRACT

The invention relates to a warming article comprising a heating element and a sensing system, wherein the sensing system comprises a first sensor element being a temperature dependent variable resistor and a second sensor element being a variable resistor, and wherein the first sensor element is linear and flexible and the second sensor element is used to adjust the total sensor resistance to a fixed value at a particular temperature.

### FIELD OF THE INVENTION

The present invention refers to the temperature control of a warming article, more particularly, to a temperature control method for controlling a heater such as an electric blanket or an electric carpet in response to a detection signal from a temperature sensor arranged together with the heater in the electric blanket or carpet.

### BACKGROUND

Warming articles, such as warming blankets and warming mattress pads typically include a user control, such as a dial, that permits a user to set the relative amount of heat output of the blanket. As an example, a user control for a warming article may include settings 1 to 10, with 10 being the warmest setting, and 1 being the least warm. These settings are a relative temperature scale and a setting of 7 on one warming article may not be the same temperature as a setting of 7 on another similar article. This relative temperature measurement requires only gross determination of the temperature of the warming article. Sometimes temperature determination is also used to set an upper safe limit. In both cases, precise calibration of temperature is not required.

Furthermore, an arbitrary numbering system does not provide an intuitive idea of how warm the article will get. A user may know they are comfortable at 72 degrees Fahrenheit. It is preferable, therefore, to have a warming article in which the heating may be set using a known temperature scale rather than an arbitrary numbering scale. However, this requires a control system that has precise knowledge of the temperature of the warming article.

There is thus a need for a warming article with sensor feedback that is precisely correlated to the actual temperature such that each standardized controller will work with any sensor and warming article.

### BRIEF DESCRIPTION OF THE DRAWINGS

An embodiment of the present invention will now be described by way of example, with reference to the accompanying drawings.

FIG. 1 is a view of one embodiment of the warming article.

FIG. 2 is a view of one embodiment of the warming article sensing system with first and second sensor elements in series.

FIG. 3 is a view of one embodiment of the warming article sensing system with first and second sensor elements in parallel.

FIG. 4 is a view of one embodiment of the warming article sensing system with the first and second sensor elements in parallel and a third sensor element in series to the combination of the first and second sensor elements.

FIG. 5 is a view of one embodiment of the warming article sensing system with the first and second sensor elements in series and a third sensor element in parallel to the combination of the first and second sensor elements.

FIG. 6 is a view of one embodiment of the warming article sensing system with the second sensor element having two sections, the first section in series with the first sensor element and the second section being in parallel to the combination of the first section and first sensor element.

FIG. 7 is a view of one embodiment of the warming article sensing system.

FIG. 8 is a view of one embodiment of the warming article sensing system with a first sensor element and a calibration element.

FIG. 9 is a graph of resistance versus temperature for corrected and uncorrected sensor systems.

### DETAILED DESCRIPTION

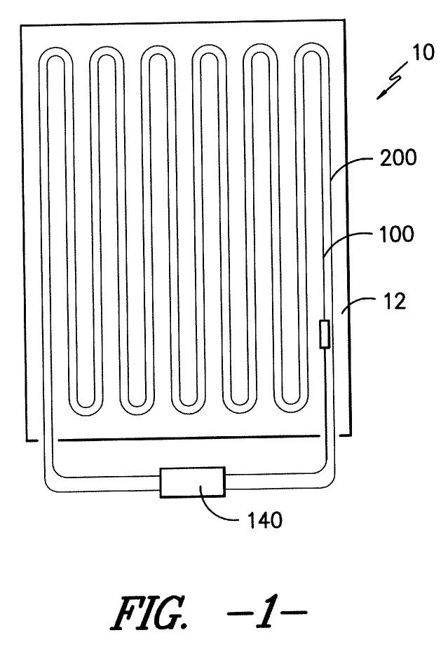

FIG. 1 shows the warming article 10 as a warming blanket comprising a heating element 200 and a sensing system 100. The heating element 200 delivers the heat through the blanket to the user, the sensing system 100 is used to sense the temperature of the blanket, and the controller 140 controls the amount of heat given off by the warming article 10.

The warming article 10 of the invention has a sensing system 100 that uses precise calibration of the sensor system such that the sensor feedback can be precisely correlated to the actual temperature. Additionally, each sensing system is calibrated so that it will work with any controller—each controller does not have to be matched to a particular sensor. Calibration and standardization means that for a set drawn from a given type of controller and sensor system, any controller will work with any sensor system and warming article. This is advantageous, for example, when a family has multiple warming blankets and removes the controllers from the blankets for laundering; the controllers are interchangeable so that the blankets could be used with any of the controllers. It has an additional advantage in production in that it is not necessary to pair and then track a particular controller and sensor system.

Similarly configured controllers may be used with any similarly configured sensor, even when there is significant variation from sensor to sensor. This variation often happens in textile-based heating systems incorporating strands of a temperature-dependent variable resistor (TDVR) as the sensor. The controller must know the baseline resistance of the sensor, the resistance at a fixed temperature. In textile-based systems it can be difficult from a practical standpoint to sufficiently control the resistance of the sensor from system to system, so that different sensors have significantly different baseline resistances.

Some arrangements for the sensing system 100 may be found in FIGS. 2-8. The sensing system, in some embodiments, comprises a first sensor element 110 which is a temperature dependent variable resistor (TDVR) and a second sensor element 120 being a variable resistor (VR). The first sensor element 110 is linear, elongated, and flexible. It runs throughout the warming article 10 so that the average temperature of the first sensor element 110 is related to the average temperature over the warming element 10. In one embodiment, the first sensor element 110 is a conductive wire. This arrangement serves to adjust the baseline resistance of the sensing system 100 to a set value that is assumed by the controller 140 by setting the resistance of the second sensor element 120. FIGS. 2-8 are schematics in which the TDVR first sensor element 110 is depicted as a resistor and the TIVR second sensor element or elements 120 are depicted as a resistor or resistors.

The first sensor element 110 is a temperature dependent variable resistor (TDVR), designed so that its resistance is directly proportional to its average temperature. The relationship between temperature and resistance is the temperature coefficient. To improve the signal-to-noise ratio when determining temperature, the TDVR may be designed to have as large a temperature coefficient as practical.

Ideally, the second sensor element 120 would have the same temperature coefficient as the first sensor element 110, that is, it would also be a TDVR. In practice, the second sensor element 120 is often part of a printed circuit board or other conventional electronic device or controller and it is not practical to be made out of the same materials as the first sensor element. As such, it is useful if the second sensor element 120 is a commercially available resistor. Such resistors typically have a much smaller temperature coefficient than does the first sensor element 110.

Often the second sensor element 120 is located outside the area over which the temperature is to be measured, in an environment where the temperature changes less than in the environment of the first sensor element 110. This further reduces the resistance change of the second sensor element 120 relative to that of the first sensor element 110. In practice, the temperature-related resistance change of the second sensor element 120 typically is much smaller that that of the first sensor element 110, and so the second sensor element 120 will be referred to as a temperature independent variable resistor (TIVR) for this specification. However, the second sensor element is not limited to being a TIVR and may be any type of variable resistor whose resistance can be externally set. To the extent that the changes in resistance of the TDVR and TIVR are different, use of the TIVR will introduce an error in the temperature measurement of the sensing system 100. This includes combinations of resistors that, for purposes of analyzing the complete circuit, can be treated as one resistor.

The resistance of the TIVR may change for reasons other than temperature (such as manual adjustment), and so it is still referred to it as a variable resistor. In fact, as is described below, it is often preferable that the manufacturer be able to adjust the resistance of the second sensor element 120. So, for example, the TIVR may be a potentiometer, or it may be a series of resistors that can be selectively included in the TIVR sensor element(s).

In order for the TDVR first sensor element 110 to respond to the temperature over large areas of the sensor system 100, the TDVR first sensor element 110 is linear and flexible. In this case, linear refers to its spatial extent, being much longer in one of its dimensions than in either of the other two dimensions. The first sensor element 110 should also be flexible, so that it can be incorporated throughout the warming article 10, for example in a serpentine pattern as shown in FIG. 1. In addition, it should not restrict the flexibility of the warming article.

The TIVR (the second sensor in FIGS. 2-8) need not be linear or flexible; as discussed above, it usually is not.

The warming article 10 measures the resistance R of the sensing system 100 including the TDVR sensor element 110 to determine the average temperature T of the sensor element 110. Ignoring for a moment the presence of the TIVR second sensor element 120, the controller can determine the average temperature from the measured resistance by using a calculation or look-up table based on
T−Tₒ=[(R/Rₒ−1)]/αₒ (Equation 1)

where Rₒ is the baseline resistance of the sensor system and αₒ is the temperature coefficient of the sensor material at temperature Tₒ. The TIVR second sensor element 120 introduces an error in this equation which is discussed below. This error can be determined and controlled so that the average temperature of the warming article can be determined. Furthermore, as will now be shown, the second sensor element allows adjustment for differences in the baseline resistance from one sensor system to another. This allows use of a single calculation or look-up table for all sensor systems and greatly increases the accuracy of the temperature determination.

In one embodiment as shown in FIG. 2, a desired baseline resistance Rₒ for the sensing system 100 is chosen that is greater than, but close to, the resistance R of the first sensor element 110. The resistance of the first sensor element 110 is measured at the baseline temperature Tₒ and a correction resistance ΔR is added in series in the second sensor element 120 so that the total resistance R+ΔR equals the desired baseline resistance Rₒ. If the resistance of the second sensor element 120 has the same TDVR behavior as the first sensor element 110, then there will be little or no error in the inferred temperature. If, as is usually practical, the added resistance has very little change with temperature, then there will be an error ΔT in the inferred temperature exactly equal to
ΔT=ΔR/Rₒ*(T−Tₒ) (Equation 2)

As before, R₀ and T₀ are the baseline resistance and temperature. The error ΔT is minimized when ΔR is minimized, so it is still desirable to minimize the distribution of resistances of the TDVR first sensor element 110. It is also desirable to choose the smallest necessary correction ΔR, keeping in mind that it must raise the resistance of the least resistive first sensor element 110 to the desired baseline resistance R₀. In practice, the error ΔT can be kept small.

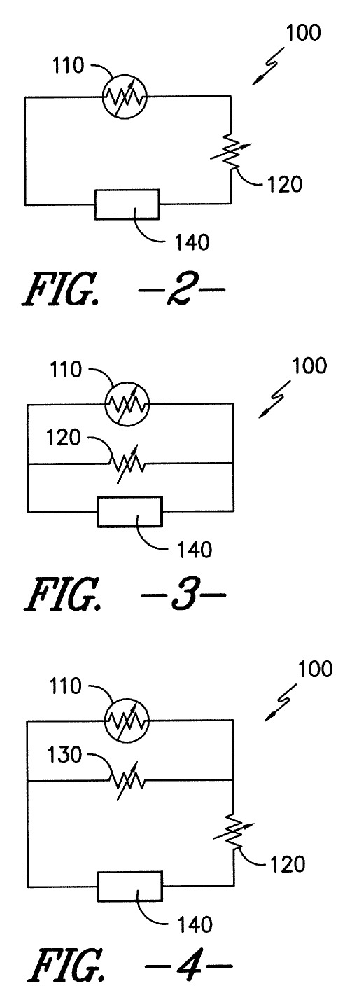

In another embodiment as shown in FIG. 3, a desired baseline resistance Rₒ for the sensing system 100 is chosen that is less than, but close to, the resistance R of the first sensor element 110. The resistance of the first sensor element 110 is measured at the baseline temperature Tₒ and a correction resistance ΔR is added in parallel in the second sensor element 120 so that the combined resistance of R and ΔR equals the desired baseline resistance Rₒ. Addition of the second sensor element 120 decreases the overall resistance of the sensor system 110, so that the desired baseline resistance Rₒ can be chosen by proper choice of ΔR.

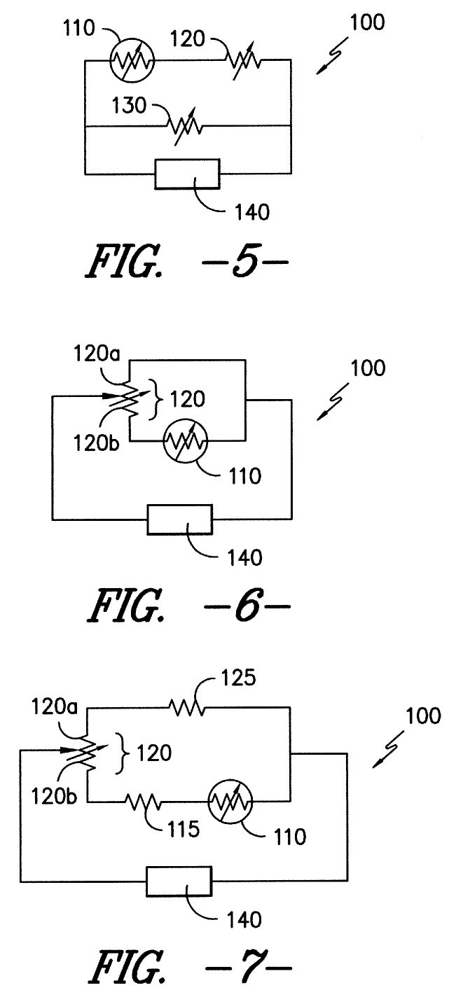

The configurations in FIGS. 2 and 3 allow adjustment of the sensor system 100 so that it has a baseline resistance Rₒ in the cases where the first sensor elements 110 have resistance R that are either all less than or all greater than the baseline resistance. FIGS. 4 and 5 show configurations that can be used in the case where the resistance R of the first sensor element 110 may be either less than or greater than the baseline resistance Rₒ. In this embodiment the sensing system 100 further comprises a third sensor element 130 being a temperature independent variable resistor (TIVR).

In one arrangement shown in FIG. 4, the first sensor element 110 is electrically connected in parallel to the third sensor element 130. The second sensor element 120 is electrically connected in series to the combination of the first sensor element 110 and the third sensor element 130. In another arrangement shown in FIG. 5, the first sensor element 110 is electrically connected in series to the second sensor element 120. The third sensor element 130 is electrically connected in parallel to the combination of the first sensor element 110 and the second sensor element 120. In either configuration, presence of the second sensor element 120 will increase the baseline resistance Rₒ, and presence of the third sensor element 130 will decrease the baseline resistance Rₒ. In this way the resistance of sensor system 100 can be adjusted either up or down to compensate for a resistance R of first sensor element 110 that is either less than or greater than desired baseline resistance Rₒ.

In another arrangement shown in FIG. 6, the second sensor element 120 is a temperature independent variable resistor (such as a potentiometer) consisting of a first section 120a and a second section 120b. The first sensor element 110 is electrically connected in series with the first section 120a of the second sensor element 120. The second section 120b of the second sensor element 120 is electrically connected in parallel with the combination of the first sensor element 110 and the first section 120a of the second sensor element 120. This arrangement provides the same abilities as the arrangement in FIGS. 4 and 5, but with the further flexibility to adjust the level of correction provided by the second sensor element. The baseline resistance Rₒ can be adjusted either up or down by adjusting the variable resistor.

In FIG. 6 when the second sensor element 120 is set to an extreme position so that the resistance of second section 120b is zero. The parallel resistance goes to zero, bypassing the TDVR first sensor element 110, reducing the total resistance of the sensor system 100 to zero and eliminating the sensitivity to temperature. At the other extreme, all the resistance from second sensor element 120 is in parallel; no resistance is available in series. In practice the second sensor element 120 would not be used at or near its extreme settings, so much of the value of the adjustable range is lost. In other words, the adjustment to the baseline resistance Rₒ is less precise than it could be if the entire range of the potentiometer were used.

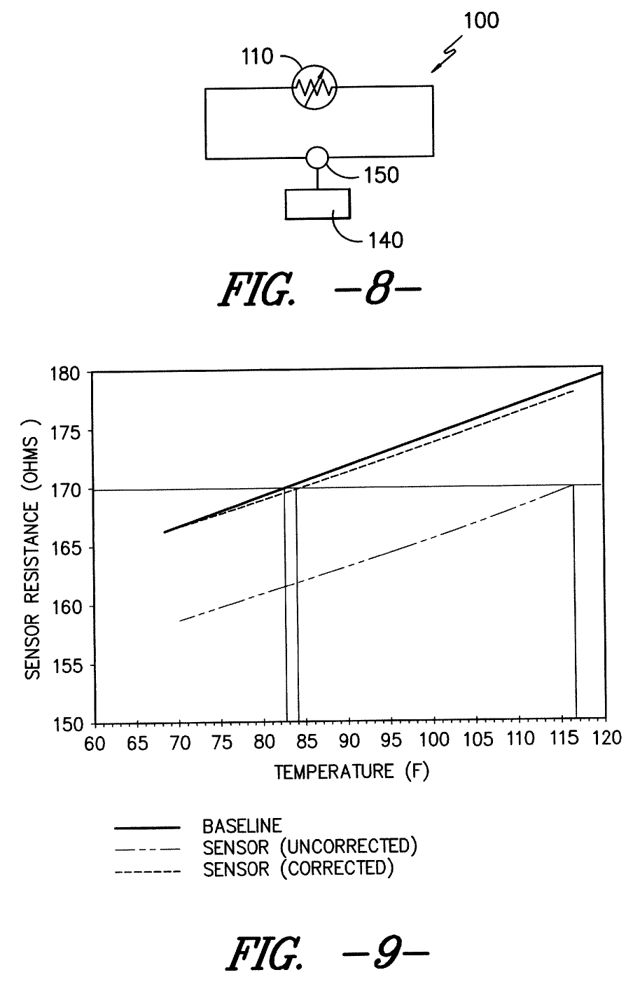

The precision can be improved by using the configuration shown in FIG. 7. The addition of resistors 115 and 125 ensures that some series and parallel resistance are added to the sensor system 100. For example, even if the potentiometer is set so that the resistance of second section 120b is zero, there is still a finite resistance (resistor 125) in parallel. Consequently, the entire range of second sensor element 120 can now be used to “fine tune” the baseline resistance Rₒ.

The next three embodiments teach automated or semi-automated methods for taking the calibration measurements and communicating the results to the controller so it can readjust its calculations accordingly.

In a second embodiment shown in FIG. 8, the sensing system 100 comprises a first sensor element 110 being a TDVR and a calibration element 150, wherein the calibration element 150 is encoded with the resistance of the first sensor element 110 at a given temperature, and wherein the first sensor element 110 is linear and flexible.

The calibration element 150 is typically a small writable electronic device, such as an integrated circuit (IC), with the baseline resistance of first sensor element 110 encoded in it so that the baseline resistance can be read by the controller 140. The IC is encoded with the baseline resistance of first sensor element 110 by an additional manufacturing step after assembly of the warming article. The baseline resistance of the first sensor element 110 is measured at a controlled and known or measured baseline temperature Tₒ and the calibration element 150 is encoded with that information. This becomes the baseline resistance Rₒ of sensor system 100. At that point an instruction can be sent to the calibration element 150 to “lock in” the programmed data, so that it can not be reprogrammed. The data is made available to an inquiring circuit, such as the controller. Therefore, when the controller is connected to the sensor system, it can query for the value of Rₒ and Tₒ as desired, to be used for example in Equation (2). The controller controls the amount of heat generated by the heating element based on the sensor resistances. This method has the advantage of being completely set up during manufacturing.

In a third embodiment, the warming article 10 comprises a sensing system 100, wherein the sensing system 100 comprises a first sensor element 110 being a TDVR and a calibration element 150 being a resistance temperature device (RTD), wherein the RTD senses the ambient temperature surrounding the warming article, and wherein the first sensor element 110 is linear and flexible. The warming article 10 also has a controller 140 that reads the ambient temperature input from the calibration element and measures the resistance of the first sensor element 110, and sets a correspondence between the temperature from the calibration element and the resistance from the first sensor element 110.

This method includes a means for providing the temperature at a moment when the controller is measuring the resistance, and this pair of values is used as a (potentially new) set of baseline values (Rₒ, Tₒ) along with an appropriately adjusted value of the temperature coefficient αₒ′.

At any time, the controller element 150 can be told to calibrate itself, for example, by pressing a calibration button. The controller then reads the temperature as given by the temperature measuring device and the resistance of the sensor and sets these as the new values of Rₒ and Tₒ. This method has the advantage of allowing the system to be recalibrated as necessary, but it assumes the temperature of the first sensor element 110 is the same as the temperature provided by the temperature measuring device. The calibration may done each time the warming article is turned on, or in another embodiment, there 6an be a recessed switch that is pressed if the user wants to recalibrate. Additionally, the warming article may include a writable electronic device in which the correspondence between the temperature from the calibration element and the resistance from the first sensor element 110 is encoded.

In this method the baseline temperature Tₒ can change. The new baseline resistance Rₒ is measured directly. The new temperature coefficient αₒ can be calculated or read from a look-up table based on the equation
αₒ=aᵣ/[1+αₒ(Tₒ−Tᵣ)], (Equation 3)

where αᵣ is the reference temperature coefficient at some reference temperature Tᵣ. Values of αᵣ at some defined Tᵣ are available from reference tables for a wide variety of conducting materials, including materials such as copper or nickel typically considered for sensors. For a particular novel material, such as a new conducting polymer, the value of αᵣ can be determined experimentally.

In a fourth embodiment, the warming article 10 comprises a sensing system 100, wherein the sensing system 100 comprises a first sensor element 110 being a temperature dependent variable resistor and a calibration element 150, wherein the calibration element 150 is encoded with a user input of baseline temperature, and wherein the first sensor 110 element is linear and flexible. The controller element 150 measures the resistance of the first sensor element 110 and sets a correspondence between the user input temperature from the calibration element 150 and the resistance from the first sensor element 110. The fourth method removes the need for the temperature measuring device and replaces it by requiring the user to input the temperature using the controller Interface, much in the same way the user can input a set point (desired) temperature. In this case, allowance can be made for the fact that the sensor may be at an elevated temperature, but it is necessary for the user to know the temperature of the sensor. Again, information is used to set new values of Rₒ and Tₒ.

Preferably the sensing system controls the warming article temperature to within two degrees Fahrenheit of the set point, more preferably to within one degree Fahrenheit.

Any conductive material can be used for the TDVR sensor element, so long as the conductivity changes over the temperature range to be monitored, and the material can be made into flexible strands. Conductivity of the TDVR can either increase or decrease with temperature. The larger the temperature coefficient αᵣ of the material, the greater the signal of a change in temperature. It is preferable that the temperature behavior of the material be stable over time. It is also preferable that the resistance have a linear dependence on the temperature over the range of interest.

Preferred materials for the TDVR sensor strands include most metals, including copper, silver, and stainless steel. Among common metals, nickel has a particularly high temperature coefficient. Copper is highly ductile and readily available as strands. Metals may be incorporated as wires or strands, or they may be incorporated as strands wrapped around a flexible nonconductive core, such as a plastic filament yarn. They may also be coatings on flexible nonconductive strands.

Preferred materials also include conductive polymers, including intrinsically conducting polymers (ICPs) such as polypyrrole, polyaniline, and polythiophene and yams or strands coated with ICPs, as well as nonconductive polymers loaded with conductive particles such as carbon particles, metal particles, metal coated glass beads, metal oxide particles, and metal oxide coated glass beads. Such materials often have larger coefficients than metals, such as described in U.S. Pat. No. 6,497,591.

Other preferred materials include semiconductors, such as silicon or germanium, which often have large temperature coefficients. While these materials may not be flexible, when formed into thin strands or used as coatings on flexible nonconductive strands they can be included as a flexible sensor.

The warming article 10 may be heated garments, such as jackets, sweaters, hats, gloves, shirts, pants, socks, boots, and shoes, and/or home furnishing textile articles, such as blankets, throws, warming pads, warming mats, seat warmers, mattress pads, mattresses, seating, and upholstery. The warming article 10 may contain fabric that is of any stitch construction suitable to the end use, including by not limited to a woven, knitted, non-woven material, tufted materials, or the like. Woven textiles can include satin, twill, basket-weave, poplin, and crepe weave textiles. Jacquard woven structures are also preferred as they are able to create a more complex electrical pattern.

In addition to apparel and home furnishings, the warming article may be configured to provide heat to any number of consumer products such as baby bottles, baby carriages, pet accessories, pool coverings, vehicle seats, or floor coverings such as carpets, tile, or wood. The warming article may also be configured to provide heat to military troop gear such as sleeping bags, hospital and patient products, or farming products such as for livestock. The warming article may also be utilized to melt snow on, for example, a sidewalk or driveway. Additional examples, too numerous to mention, are also contemplated.

The warming article 10 is electrically connected to a power source to supply electrical power for heat generation. Electricity may be applied in many methods, including but not limited to a cigarette lighter or other power outlet of an automobile, alternating current from a household outlet, or direct current from, for example a battery pack. Additional alternative power sources include photovoltaic panels and fuel-cells.

The warming article 10 may incorporate several safety devices and indications to protect the user from potential injury. For example, if the temperature of the warming article climbs above a certain temperature, the controller 140 may automatically shut off the power to the warming article. Alternatively, the controller may prevent the user from setting the temperature too high.

The warming article 10 may be treated to be hydrophobic. Additionally, in one embodiment, barrier layers may be applied to the outside surfaces of the warming article 10. The barrier layers serve to isolate the warming article 10 from the environment or water. The barrier layers are electrically insulating and impermeable to both water and water vapor. Preferably, the barrier layer is made of polyvinyl chloride, polyurethane, silicone, neoprene, or other known barrier layers with the desired physical characteristics.

### EXAMPLE

A linear, flexible, 104 foot long TDVR baseline sensor was made by wrapping a 36 AWG wire made of Percon 19 metal (available from Fisk Alloy Conductors, Incorporated of Hawthorne, N.J.) around a 1000 denier polyester filament yarn at 50 turns per inch and coating with PVC insulation. The resistance of the sensor is shown in FIG. 9 labeled as “Baseline.” A second sensor was made, identical to the baseline sensor in all respects except that the second sensor was only 99 feet long. The resistance of the second sensor is shown in FIG. 9 labeled as “Sensor (uncorrected).” Finally, a calibration resistor was added in series to the second sensor. The resistance of the sensor-resistor pair is shown in FIG. 9 labeled as “Sensor (corrected).” Even though the added resistor is, practically speaking, a temperature independent resistor, it adjusts the resistance of the second sensor system so that it matches the baseline resistance over a wide temperature range.

For example, the baseline system has a resistance of 170 ohms at a temperature of 82.5 F. That same resistance occurs in the uncorrected sensor at a temperature of 116.5 F—an error of 34 degrees. In the corrected system, a resistance of 170 ohms occurs at 84 F, an error of only 1.5 degrees. The calibrating resistor reduces the error 96%.

It is intended that the scope of the present invention include all modifications that incorporate its principal design features, and that the scope and limitations of the present invention are to be determined by the scope of the appended claims and their equivalents. It also should be understood, therefore, that the inventive concepts herein described are interchangeable and/or they can be used together in still other permutations of the present invention, and that other modifications and substitutions will be apparent to those skilled in the art from the foregoing description of the preferred embodiments without departing from the spirit or scope of the present invention.

1. A warming article comprising a heating element and a sensing circuit, wherein the sensing circuit comprises a first sensor element being a temperature dependent variable resistor, a second sensor element being a temperature independent variable resistor, and a third sensor element being a temperature independent variable resistor, an wherein the first sensor element is linear and flexible.

2. The warming article of claim 1, wherein the second sensor element comprises a combination of resistors.

3. The warming article of claim 1, wherein the first sensor element is electrically connected in series to the second sensor element.

4. The warming article of claim 1, wherein the first sensor element is electrically connected in parallel to the second sensor element.

5. The warming article of claim 1, wherein the first sensor element is electrically connected in parallel to the third sensor element and wherein the second sensor element is electrically connected in series to the combination of the first sensor element and the third sensor element.

6. The warming article of claim 1, wherein the first sensor element is electrically connected in series to the second sensor element and wherein the third sensor element is electrically connected in parallel to the combination of the first sensor element and the second sensor element.

7. The warming article of claim 1, wherein the second sensor element comprises a first section and a second section, wherein the first sensor element is electrically connected in series with the first section of the second sensor element and the second section of the second sensor element is electrically connected in parallel with the combination of the first sensor element and the first section of the second sensor element.

8. The warming article of claim 1, further comprising a controller element, wherein the controller measures the resistance of the sensing system and controls the amount of heat generated by the heating element.

9. The warming article of claim 1, wherein the heating element and the sensing system are incorporated into a fabric.

10. The warming article of claim 1, wherein the first sensing element is an electrically conductive wire.

11. A warming article comprising a heating element and a sensing system, wherein the sensing system comprises a first sensor element being a temperature dependent variable resistor and a calibration element, wherein the calibration element is encoded with the resistance of the first sensor element at a measured baseline temperature, and wherein the first sensor element is linear and flexible.

12. The warming article of claim 11, further comprising a controller element, wherein the controller reads the resistance of the first sensor element from the calibration element and controls the amount of heat generated by the heating element.

13. The warming article of claim 11, wherein the heating element and the sensing system are incorporated into a fabric.

14. The warming article of claim 11, wherein the first sensor element is an electrically conductive wire.

15. A warming article comprising a heating element and a sensing system, wherein the sensing system comprises a first sensor element being a temperature dependent variable resistor and a calibration element being an independent temperature sensor, wherein the independent temperature sensor senses the ambient temperature surrounding the warming article, and wherein the first sensor element is linear and flexible.

16. The warming article of claim 15, further comprising a controller element, wherein the controller element reads the ambient temperature input from the calibration element and measures the resistance of the first sensor element, and sets a correspondence between the temperature from the calibration element and the resistance from the first sensor element.

17. The warming article of claim 16, wherein the controller sets a correspondence between the temperature from the calibration element and the resistance from the first sensor element each time the controller is turned on.

18. The warming article of claim 16, further comprising a writable electronic device, wherein the correspondence between the temperature from the calibration element and the resistance from the first sensor element is encoded in the writable electronic device.

19. The warming article of claim 15, wherein the heating element and the sensing system are incorporated into a fabric.

20. The warming article of claim 15, wherein the first sensor element is an electrically conductive wire.

21. A warming article comprising a heating element and a sensing system, wherein the sensing system comprises a first sensor element being a temperature dependent variable resistor and a calibration element, wherein the calibration element is encoded with a user input of room temperature, and wherein the first sensor element is linear and flexible.

22. The warming article of claim 21, further comprising a controller element, wherein the controller element reads the resistance of the first sensor element and sets a correspondence between the encoded temperature from the calibration element and the resistance from the first sensor element.

23. The warming article of claim 21, wherein the heating element and the sensing system are incorporated into a fabric.

24. The warming article of claim 21, wherein the first sensor element is an electrically conductive wire.
